(19) United States
(12) Patent Application Publication
(10) Pub. No.: US 2016/0254610 A1
(43) Pub. Date: Sep. 1, 2016

(54) Female Terminal Fitting

(71) Applicant: YAZAKI CORPORATION, Minato-ku, Tokyo (JP)

(72) Inventors: Takayoshi Hirakawa, Kakegawa-shi (JP); Hidehiko Kuboshima, Kakegawa-shi (JP)

(73) Assignee: Yazaki Corporation, Minato-ku, Tokyo (JP)

(21) Appl. No.: 15/027,622

(22) PCT Filed: Oct. 7, 2014
(86) PCT No.: PCT/JP2014/076865

§ 371 Date: Apr. 6, 2016

(30) Foreign Application Priority Data
Oct. 7, 2013 (JP) 2013-210434

(51) Int. Cl. H01R 13/187; H01R 43/16; H01R 4/18

(52) U.S. Cl. CPC H01R 13/187; H01R 4/18; H01R 43/16

(57) ABSTRACT

In the first frame (21) and the second frame (22) of a terminal contact spring member (20) which are inscribed in the quadrangular tube-shaped terminal fitting unit (11) of the female terminal main body (10), a height dimension (H3) of side wall sections (21c, 22c) in a sheet thickness direction of the contact flat plate section (210) before being mounted is greater than an inner height dimension (H4) of the terminal fitting unit (11) corresponding thereto, and a curved shape portion (R), which enables the height dimension (H3) of the side wall sections (21c, 22c) to extend and contract in the height direction, is provided on the side wall section (21c, 22c).

### TECHNICAL FIELD

The present invention relates to a female terminal fitting.

### BACKGROUND ART

FIG. 4 illustrates a female terminal fitting disclosed in PTL 1 to be described below. A female terminal fitting 100 is configured to include a female terminal main body 110 formed of a metal sheet and a terminal contact spring member 120 formed of a metal sheet thinner than a sheet thickness of the female terminal main body 110.

The female terminal main body 110 includes a terminal fitting unit 111 having quadrangular tube shape, into which a contact flat plate section 210 of a male terminal fitting is inserted as a connection counterpart, and an electric wire connecting unit 112 which is provided to be continuous to the terminal fitting unit 111 and in which electric wires are connected.

Inside the terminal fitting unit 111, a protrusion 111a, which regulates movement of the terminal contact spring member 120 which is mounted inside the terminal fitting unit 111 in an insertion direction, is formed.

The electric wire connecting section 112 is a section where crimp connection of the electric wires is performed.

The terminal contact spring member 120 is mounted on the terminal fitting unit 111 in a state of being in contact with an inner surface of the terminal fitting unit 111.

The terminal contact spring member 120 is formed to have a quadrangle tubular shape by bending a conductive metal sheet. In FIG. 5, a mating portion (abutting portion) 130 between edges of bent metal sheets is formed of a fine gap. As illustrated in FIG. 5, the terminal contact spring member 120 includes a first frame 121, a second frame 122, first flat springs 123a and 123b, and a second flat spring 126.

The first frame 121 is formed to have a quadrangular shape which is inscribed in a front end portion 1111 of the terminal fitting unit 111, which becomes an insertion side of the contact flat plate section 210. As illustrated in FIG. 5, the first frame 121 is formed to be a quadrangular frame having a pair of first facing walls 121a and 121b which face one surface 211 of the contact flat plate section 210 inserted into the terminal fitting unit 111, a second facing wall 121c which faces the other surface 212 of the contact flat plate section 210, and a side wall section 121d which is continuous to the first facing walls 121a and 121b and the second facing wall 121c. The pair of first facing walls 121a and 121b of the first frame 121 are divided into the right and left sides in a width direction of the contact flat plate section 210, due to the mating portion 130.

The second frame 122 is formed to have a quadrangular shape which is inscribed in a rear end portion 1112 of the terminal fitting unit 111. As illustrated in FIG. 5, the second frame 122 is formed to be a quadrangular frame having a pair of first facing walls 122a and 122b which face the one surface 211 of the contact flat plate section 210 inserted into the terminal fitting unit 111, a second facing wall 122c which faces the other surface 212 of the contact flat plate section 210, and a side wall section 122d which is continuous to the first facing walls 122a and 122b and the second facing wall 122c. The pair of first facing walls 122a and 122b of the second frame 122 are divided into the right and left sides in a width direction of the contact flat plate section 210, due to the mating portion 130.

As illustrated in FIG. 6, both the side wall section 121d of the first frame 121 and the side wall section 122d of the second frame 122 are set to have a height dimension H1 in a sheet thickness direction of the contact flat plate section 210, which is less than an inner height dimension H2 corresponding to the terminal fitting unit 111. Instead, the first facing walls 121a and 121b of the first frame 121 and the first facing walls 122a and 122b of the second frame 122 are configured to have free end sides which are inclined so as to protrude upward (in FIG. 6, upward) and come into elastic contact with an inner wall surface of the terminal fitting unit 111 such that the first frame 121 and the second frame 122 come into reliable contact with the terminal fitting unit 111.

The first flat spring 123a straddles over the first facing wall 121a of the first frame 121 and the first facing wall 122a of the second frame 122 and comes into elastic contact with the one surface 211 of the contact flat plate section 210. The first flat spring 123a is formed to have a convex arc shape on the one surface 211 of the contact flat plate section 210 in a side view, and an intermediate portion which is the apex of an arc comes into contact with the one surface 211 of the contact flat plate section 210.

The first flat spring 123b straddles over the first facing wall 121b of the first frame 121 and the first facing wall 122b of the second frame 122 and comes into elastic contact with the one surface 211 of the contact flat plate section 210. Similar to the first flat spring 123a, the first flat spring 123b is formed to have a convex arc shape on the one surface 211 of the contact flat plate section 210 in a side view, and an intermediate portion which is the apex of an arc comes into contact with the one surface 211 of the contact flat plate section 210.

The second flat spring 126 straddles over the second facing wall 121c of the first frame 121 and the second facing wall 122c of the second frame 122 and comes into elastic contact with the other surface 212 of the contact flat plate section 210. The second flat spring 126 is formed to have a convex arc shape on the other surface 212 of the contact flat plate section 210, in a side view, and an intermediate portion which is the apex of an arc comes into contact with the other surface 212 of the contact flat plate section 210.

### CITATION LIST

### Patent Literature

[PTL 1] JP-A-2002-100430

### SUMMARY OF INVENTION

### Technical Problem

However, as illustrated in FIG. 6, in an attachment structure in which free ends of the first facing walls 121a and 121b of the first frame 121 and the first facing walls 122a and 122b of the second frame 122 come into contact with the inner wall surface of the terminal fitting unit 111, it is difficult to secure high contact pressure, and thus, there is a concern that an electrical connection state will be unstable between the terminal contact spring member 120 and the female terminal main body 110 due to the insufficient contact pressure. Also, the electrically unstable connection state between the terminal contact spring member 120 and the female terminal main body 110 results in variations in quality, and then it is difficult to secure stable electrical properties due to the variations in quality.

Therefore, in order to solve the above problem, an object of the present invention is to provide a female terminal fitting with which an electrical connection state becomes stable between a female terminal main body and a terminal contact spring member which comes into contact with a contact flat plate section of a male terminal fitting, and thus, stable electrical properties can be secured.

### Solution to Problem

The object described above of the present invention is achieved by the following configurations.

(1) There is provided a female terminal fitting comprising:
a female terminal main body having a terminal fitting unit with a quadrangular tube shape, into which a contact flat plate section of a male terminal fitting is inserted as a connection counterpart; and
a terminal contact spring member which is mounted on the terminal fitting unit in a state of being in contact with an inner surface of the female terminal main body,
wherein the terminal contact spring member includes:
   a first frame having substantially a quadrangular shape which is inscribed in a front end portion of the terminal fitting unit as an insertion side of the contact flat plate section,
   a second frame having substantially a quadrangular shape which is inscribed in a rear end portion of the terminal fitting unit,
   a first flat spring which straddles over first facing walls of the first frame and the second frame which face one surface of the contact flat plate section which is inserted into the terminal fitting unit, and comes into elastic contact with the one surface of the contact flat plate section, and
   a second flat spring which straddles over second facing walls of the first frame and the second frame which face the other surface of the contact flat plate section which is inserted into the terminal fitting unit, and comes into elastic contact with the other surface of the contact flat plate section, and
wherein a height dimension of side wall sections of the first frame and the second frame in a sheet thickness direction of the contact flat plate section before being mounted is greater than an inner height dimension of the terminal fitting unit corresponding thereto, and
a curved shape portion, which enables the height dimension of the side wall sections to extend and contract in the height direction, is provided on the side wall section.

(2) In the female terminal fitting according to (1),
the terminal contact spring member is formed by bending a conductive metal sheet into a quadrangular tube shape, and
a mating portion between edges of the metal sheet is set on one side surface side when the bending is performed so as to form the quadrangular tube shape, and the side wall sections having the curved shape portion are provided on the other side surface side.

(3) In the female terminal fitting according to (2),
side edges of side wall pieces extending from the first facing walls of the first frame and the second frame and side edges of side wall pieces extending from the second facing walls of the first frame and the second frame come into contact at the mating portion of the terminal contact spring member, respectively, and
the contact between the side edges of the side wall pieces causes relative movement of the side wall pieces from each other to be regulated in a direction parallel to the insertion direction of the contact flat plate section.

In the configuration according to (1), when the terminal contact spring member is fitted in the terminal fitting unit of the female terminal main body, the height dimension of the side wall section of the first frame and the second frame of the terminal contact spring member is set to be greater than the inner height dimension corresponding to the terminal fitting unit. Accordingly, the side wall sections of the first frame and the second frame enter into a state of being elastically deformed due to deflection of the curved shape portion in a direction in which the height dimension is reduced, and the first facing wall and the second facing wall, to which the side wall section of the first frame and the second frame is continuous, enter into a state of being in pressure contact with the facing inner wall surface of the terminal fitting unit due to a restoring force of the curved shape portion, and the terminal contact spring member and the female terminal main body enter into a conductive connection state.

Therefore, it is possible to secure high contact pressure in a contact portion with the terminal contact spring member and the female terminal main body which come into pressure contact with each other due to the deflection of the curved shape portion of the respective side wall sections of the first frame and the second frame, compared to a case where a free end of the sheet piece as illustrated in FIG. 6.

Accordingly, an electrical connection state can become stable between the terminal contact spring member and the female terminal main body. Also, an electrical connection state is stable between the terminal contact spring member and the female terminal main body, thereby allowing stable electrical properties to be secured.

In the configuration according to (2), since the terminal contact spring member has the mating portion which is set on the one side surface side of the terminal contact spring member, the first facing wall and the second facing wall, to which the other side wall section having the curved shape portion is continuous, have a symmetrical structure. Accordingly, an elastic restoring force of the curved shape portion can be uniformly applied to the first facing wall and the second facing wall. Therefore, it is possible to further stabilize the electrical connection state between the terminal contact spring member and the female terminal main body.

In the configuration according to (3), when the contact flat plate section of the male terminal fitting is inserted into and is removed from between the first flat spring and the second flat spring of the terminal contact spring member, the side edge of the side wall piece extending from the first facing wall comes into contact with the side edge of the side wall piece extending from the second facing wall on the side wall section provided on the one side surface side which becomes the mating portion of the terminal contact spring member, thereby regulating the relative movement of the side wall pieces from each other in the direction parallel to the insertion direction of the contact flat plate section such that deflection on the piece side of the terminal contact spring member is prevented.

Accordingly, during the insertion and removal of the contact flat plate section of the male terminal fitting, it is possible to easily perform the insertion and removal operations of the contact flat plate section without interfering with an insertion and removal operation of the contact flat plate section due to the deflection of the terminal contact spring member.

### Advantageous Effects of Invention

In the female terminal fitting according to the present invention, an electrical connection state becomes stable between a female terminal main body and a terminal contact spring member which comes into contact with a contact flat plate section of a terminal fitting, and thus stable electrical properties can be secured.

Hereinafter, the present invention will be briefly described. Further, the present invention will be clear in detail by reading through modes for carrying out the invention (hereinafter, referred to as an “embodiment”) with reference to the accompanying drawings.

### BRIEF DESCRIPTION OF DRAWINGS

FIG. 1(A) is a perspective view of an embodiment of a female terminal fitting according to the present invention and FIG. 1(B) is a perspective view of a terminal contact spring member which is mounted on a female terminal main body illustrated in FIG. 1(A).

FIG. 2 is a front view of the female terminal fitting illustrated in FIG. 1(A).

FIG. 3 is another perspective view, at a different angle, of the terminal contact spring member illustrated in FIG. 1(B).

FIG. 4 is a vertical sectional view of a female terminal fitting in the related art.

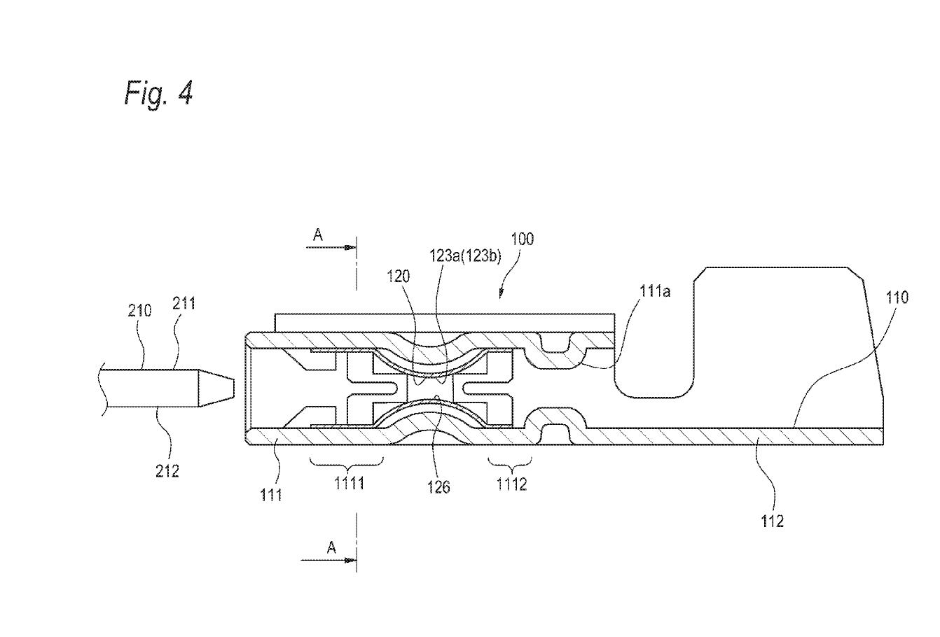

FIG. 5 is a perspective view of a terminal contact spring member which is mounted on a female terminal main body illustrated in FIG. 4.

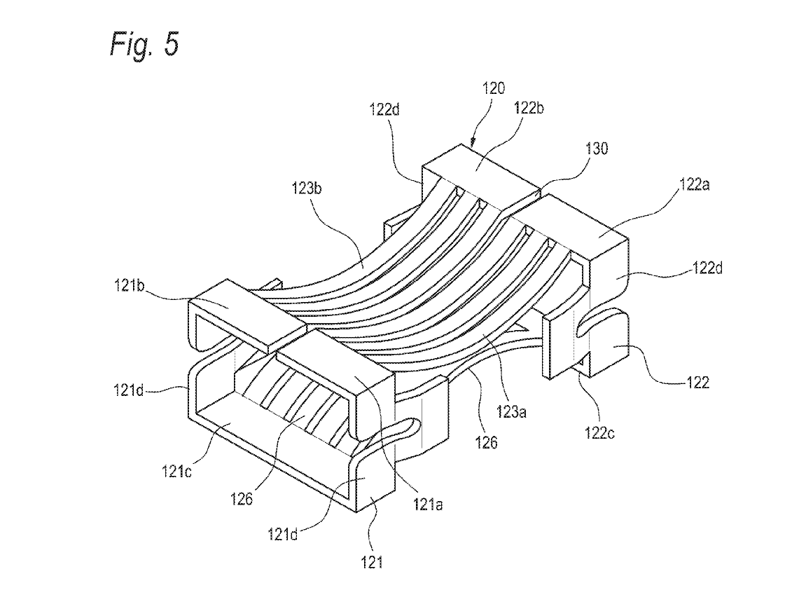

FIG. 6 is a sectional view taken along line A-A in FIG. 4.

### DESCRIPTION OF EMBODIMENTS

Hereinafter, a preferred embodiment of a female terminal fitting according to the present invention will be described in detail with reference to the drawings.

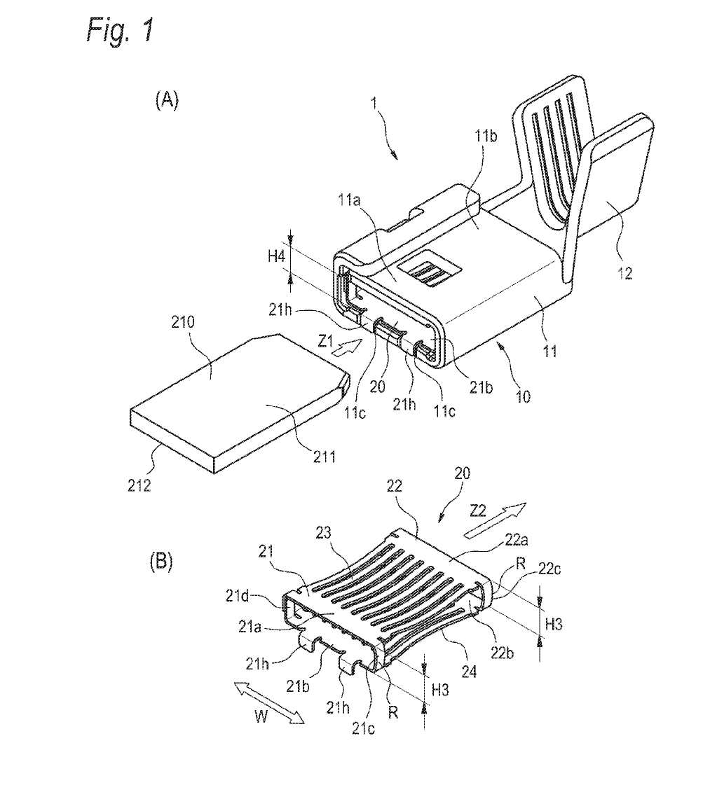

As illustrated in FIGS. 1(A) to 3, a female terminal fitting 1 according to an embodiment of the present invention is configured to include a female terminal main body 10 formed of a metal sheet, and a terminal contact spring member 20 formed of a metal sheet thinner than a sheet thickness of the female terminal main body 10.

As illustrated in FIG. 1(A), the female terminal main body 10 includes a terminal fitting unit 11 having a quadrangular tube shape, into which a contact flat plate section 210 of a male terminal fitting is inserted as a connection counterpart, and an electric wire connecting section 12 which is provided to be continuous to the terminal fitting unit 11 and in which electric wires (not illustrated) are connected. Arrow Z1 illustrated in FIG. 1(A) represents an insertion direction of the contact flat plate section 210 to the terminal fitting unit 11.

The terminal fitting unit 11 is molded in a quadrangular tube die having a wide width by bending a conductive metal sheet. The electric wire connecting section 12 is a section in which crimp connection of the electric wires is performed.

The terminal contact spring member 20 is mounted on the terminal fitting unit 11 in a state of being in contact with the inner surface of the terminal fitting unit 11. Arrow Z2 illustrated in FIG. 1(B) represents the insertion direction of the terminal contact spring member 20 to the terminal fitting unit 11.

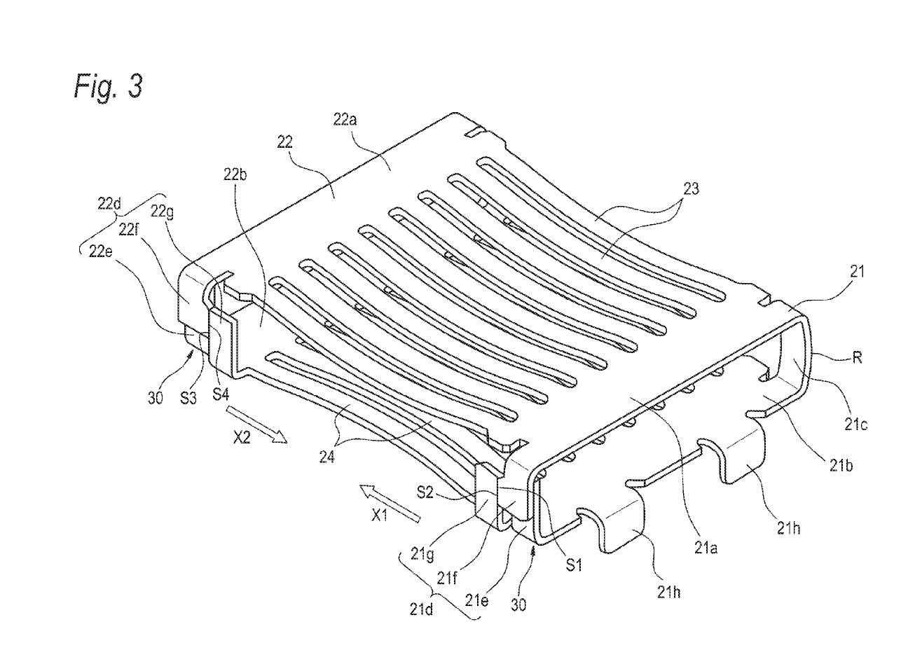

The terminal contact spring member 20 is formed to have a quadrangular tube shape by bending a conductive metal sheet. In addition, as illustrated in FIG. 3, in the terminal contact spring member 20 of the present embodiment, a mating portion 30 between edges of a metal sheet is provided on one side surface (side surface viewed from front in FIG. 3) side during the bending so as to form the quadrangular tube shape and side wall sections 21c and 22c having the curved shape portion R to be described below are provided on the other side surface side. As illustrated in FIG. 1(B) and FIG. 3, the terminal contact spring member 20 includes a first frame 21, a second frame 22, a first flat spring 23, and a second flat spring 24.

The first frame 21 is formed to have a quadrangular shape which is inscribed in a front end portion 11 a (refer to FIG. 1(A)) of the terminal fitting unit 11, which becomes an insertion side (entrance side) of the contact flat plate section 210. As illustrated in FIG. 1(A), the first frame 21 forms a quadrangular frame with a first facing wall 21a facing one (upper side in FIG. 1(A)) surface 211 of the contact flat plate section 210 into which the terminal fitting unit 11 is inserted, a second facing wall 21b facing the other surface 212 of the contact flat plate section 210, a side wall section 21c which is continuous to the first facing wall 21a and the second facing wall 21b, and a side wall section 21d having three side wall pieces 21e, 21f, and 21g.

As illustrated in FIG. 1(B), locking pieces 21h are formed by bending downward at two positions separated in the width direction (arrow W direction in FIG. 1(B)) at the front end of the second facing wall 21b of the first frame 21. As illustrated in FIG. 1(A), the locking pieces 21h are locked to notches 11c formed at the front end of the terminal fitting unit 11, thereby regulating movement of the terminal contact spring member 20 in the insertion direction. In addition, in the terminal contact spring member 20, the locking pieces 21h are locked to the notches 11c, thereby regulating movement in the width direction (arrow W direction in FIG. 1(B)) such that positional shift is prevented.

As illustrated in FIG. 3, the side wall section 21d set on the one side surface side of the first frame 21 is formed to have the three side wall pieces 21e, 21f, and 21g. In the three side wall pieces 21e, 21f, and 21g, the side wall piece 21e is formed to rise upward from the end portion of the second facing wall 21b. In addition, a frame structure, in which the side wall piece 21f extends downward from the end portion of the first facing wall 21a and overlaps an outer side of the side wall piece 21e such that no gap is formed in the mating portion 30. In addition, the side wall piece 21g is shifted to a position away from the side wall piece 21e in the insertion direction (arrow X1 direction in FIG. 3) of the contact flat plate section 210 and is formed to rise upward from the end portion of the second facing wall 21b. As illustrated in FIG. 3, the side wall piece 21g has a side edge S1 positioned on the front side in the insertion direction of the contact flat plate section 210, which comes into contact with a side edge S2 positioned on the rear side of the side wall piece 21f in the insertion direction of the contact flat plate section 210 such that movement of the side wall piece 21f in the arrow X1 direction is regulated.

The second frame 22 is formed to have a quadrangular shape which is inscribed in the rear end portion 11b (refer to FIG. 1(A)) of the terminal fitting unit 11. As illustrated in FIG. 1(B), the second frame 22 forms a quadrangular frame with a first facing wall 22a facing the one surface 211 of the contact flat plate section 210 into which the terminal fitting unit 11 is inserted, a second facing wall 22b facing the other surface 212 of the contact flat plate section 210, a side wall section 22c which is continuous to the first facing wall 22a and the second facing wall 22b, and a side wall section 22d having three side wall pieces 22e, 22f, and 22g.

As illustrated in FIG. 3, the side wall section 22d set on the one side surface side of the second frame 22 is formed to have the three side wall pieces 22e, 22f, and 22g. In the three side wall pieces 22e, 22f, and 22g, the side wall piece 22e is formed to rise upward from the end portion of the second facing wall 22b. In addition, a frame structure, in which the side wall piece 22f extends downward from the end portion of the first facing wall 22a and overlaps an outer side of the side wall piece 22e such that no gap is formed in the mating portion 30. In addition, the side wall piece 22g is shifted to a position away from the side wall piece 22e in a direction opposite (arrow X2 direction in FIG. 3) to the insertion direction of the contact flat plate section 210 and is formed to rise upward from the end portion of the second facing wall 22b. As illustrated in FIG. 3, the side wall piece 22g has a side edge S3 positioned on the rear side in the insertion direction of the contact flat plate section 210, which comes into contact with a side edge S4 positioned on the front side of the side wall piece 22f in the insertion direction of the contact flat plate section 210 such that movement of the side wall piece 22f in the arrow X2 direction is regulated.

In other words, the side edge S2 in the side wall piece 21f extending from the first facing wall 21a of the first frame 21, which is positioned on the rear side in the insertion direction of the contact flat plate section 210, comes into contact with the side edge S1 in the side wall piece 21g extending from the second facing wall 21b of the first frame 21, which is positioned on the front side in the insertion direction of the contact flat plate section 210, such that the movement of the side wall piece 21f is regulated in the arrow X1 direction in FIG. 3.

Further, the side edge S4 in the side wall piece 22f extending from the first facing wall 22a of the second frame 22, which is positioned on the front side in the insertion direction of the contact flat plate section 210, comes into contact with the side edge S3 in the side wall piece 22g extending from the second facing wall 22b of the second frame 22, which is positioned on the rear side in the insertion direction of the contact flat plate section 210, such that the movement of the side wall piece 22f is regulated in the arrow X2 direction in FIG. 3.

In other words, the side wall piece 21f comes into contact with the side wall piece 21g, and the side wall piece 22f comes into contact with the side wall piece 22g, such that the relative movement of the respective side wall pieces 21f, 22f, 21g, and 22g is regulated in the direction parallel to the insertion direction of the contact flat plate section 210, and it is possible to prevent the positional shift on the mating portion 30, due to friction force applied to the terminal contact spring member 20 during the inserting and removal of the contact flat plate section 210.

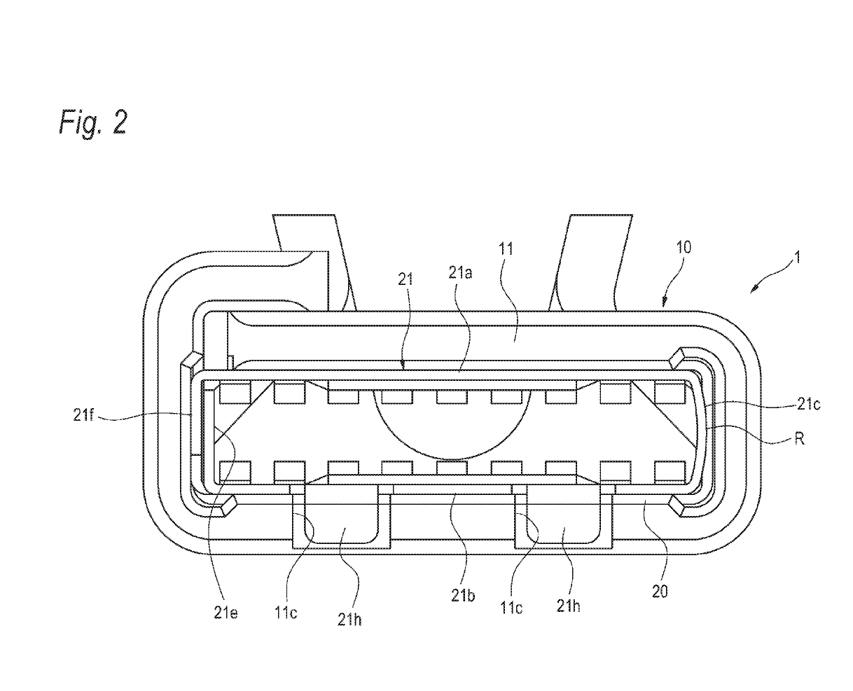

In a case of using the terminal contact spring member 20 of the present embodiment, the side wall section 21c of the first frame 21 and the side wall section 22c of the second frame 22 are set to have a height dimension H3 (refer to FIG. 1(B)) in the sheet thickness direction of the contact flat plate section 210, greater than the inner height dimension H4 (refer to FIG. 1(A)) corresponding to the terminal fitting unit 11. In addition, in the case of the present embodiment, as illustrated in FIG. 2, the side wall section 21c and the side wall section 22c have the curved shape portion R which enables the height dimension H3 of the side wall sections 21c and 22c to extend and contract in the height direction. The curved shape portion R of the present embodiment is bent such that the entire side wall sections 21c and 22c form a convex arc shape on the outer side.

The first flat spring 23 straddles over the first facing wall 21a of the first frame 21 and the first facing wall 22a of the second frame 22 and comes into elastic contact with the one surface 211 of the contact flat plate section 210. A plurality of first flat springs 23 are provided in parallel. In addition, the first flat spring 23 is formed to have a convex arc shape on the one surface 211 side of the contact flat plate section 210 and an intermediate portion as an apex of the arc comes into contact with the one surface 211 of the contact flat plate section 210.

The second flat spring 24 straddles over the second facing wall 21b of the first frame 21 and the second facing wall 22b of the second frame 22 and comes into elastic contact with the other surface 212 of the contact flat plate section 210. A plurality of second flat springs 24 are provided in parallel. In addition, the second flat spring 24 is formed to have a convex arc shape on the other surface 212 side of the contact flat plate section 210 and an intermediate portion as an apex of the arc comes into contact with the other surface 212 of the contact flat plate section 210.

In the case of the female terminal fitting 1 of an embodiment described above, when the terminal contact spring member 20 is fitted in the terminal fitting unit 11 of the female terminal main body 10, the height dimension H3 of the side wall sections 21c and 22c of the first frame 21 and the second frame 22 of the terminal contact spring member 20 is set to be greater than the inner height dimension H4 corresponding to the terminal fitting unit 11. Accordingly, the side wall sections 21c and 22c of the first frame 21 and the second frame 22 enter into an elastically deformed state in a direction in which the height dimension H3 is contracted due to the deflection of the curved shape portion R. The first facing walls 21a and 22a and the second facing walls 21b and 22b, to which the side wall sections 21c and 22c are continuous due to the elastic deformation of the side wall section 21c and 22c, enter into a state of coming into pressure contact with the inner wall surface of the facing terminal fitting unit 11 due to the restoring force of the curved shape portion R and the terminal contact spring member 20 and the female terminal main body 10 enter into a conductive connection state.

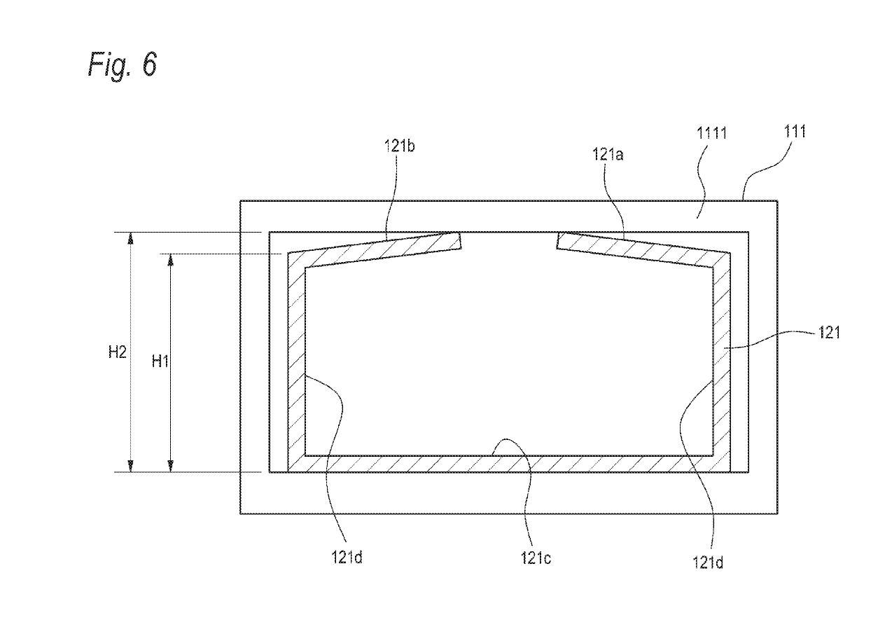

Also, it is possible to secure high contact pressure at the contact portion of the terminal contact spring member 20 and the female terminal main body 10 which are brought into pressure contact due to the deflection of the curved shape portion R of the respective side wall sections 21c and 22c of the first frame 21 and the second frame 22, compared to a case in which a free end of a plate piece as illustrated in FIG. 6.

Accordingly, an electrical connection state can become stable between the terminal contact spring member 20 and the female terminal main body 10. Also, an electrical connection state is stable between the terminal contact spring member 20 and the female terminal main body 10, thereby allowing stable electrical properties to be secured.

In addition, in the case of the female terminal fitting 1 of an embodiment described above, since the terminal contact spring member 20 has the mating portion 30 which is set on the one side surface side of the terminal contact spring member 20, the first facing walls 21a and 22a, and the second facing walls 21b and 22b, to which the side wall sections 21c and 22c provided on the other side surface side having the curved shape portion R is continuous, have a symmetrical structure. Accordingly, an elastic restoring force of the curved shape portion R can be uniformly applied to the first facing walls 21a and 22a and the second facing walls 21b and 22b. Therefore, it is possible to further stabilize the electrical connection state between the terminal contact spring member 20 and the female terminal main body 10.

In addition, in the case of the female terminal fitting 1 of an embodiment described above, when the contact flat plate section 210 of the male terminal fitting is inserted into and is removed from between the first flat spring 23 and the second flat spring 24 of the terminal contact spring member 20, the side edges S2 and S4 of the side wall pieces 21f and 22f extending from the first facing walls 21a and 22a comes into contact with the side edges S1 and S3 of the side wall pieces 21g and 22g extending from the second facing walls 21b and 22b on the side wall sections 21d and 22d provided on the one side surface side which becomes the mating portion 30 of the terminal contact spring member 20, thereby regulating the relative movement of the side wall pieces 21f and 22f and side wall pieces 21g and 22g in the direction parallel to the insertion direction of the contact flat plate section 210 such that deflection on the piece side of the terminal contact spring member 20 is prevented.

Accordingly, during the insertion and removal of the contact flat plate section 210 of the male terminal fitting, it is possible to easily perform the insertion and removal operations of the contact flat plate section 210 without interfering with the insertion and removal operations of the contact flat plate section 210 due to the deflection of the terminal contact spring member 20.

In addition, in the case of the female terminal fitting 1 of an embodiment described above, an engagement structure of the side wall pieces 21f and 22f and the side wall pieces 21g and 22g for regulating the relative movement in the direction parallel to the insertion direction of the contact flat plate section 210 is a simple engagement structure in which outer side edges (side edges S2, S4; S1, S3) come into contact with each other. Accordingly, for example, compared to a case of a configuration in which the side wall pieces 21f and 22f and the side wall pieces 21g and 22g are engaged with each other using a concave and convex structure, a complicated structure of the terminal contact spring member 20 for providing the side wall pieces 21f and 22f and the side wall pieces 21g and 22g is suppressed and it is possible to easily manufacture the terminal contact spring member 20.

Further, the present invention is not limited to the embodiments described above, but can be appropriately modified, improved, or the like. Besides, a material of, a shape of, a dimension of, the number of, a disposed position of, or the like of the respective components in the embodiment described above is not limited thereto, but is arbitrary, as long as the present invention is achieved.

For example, in the embodiment described above, the plurality of first flat springs 23 and the plurality of second flat springs 24 are provided in parallel; however, each may be provided as a single flat spring.

In addition, this application is based on Japanese Patent Application No. 2013-210434 filed Oct. 7, 2013, the content of which is incorporated herein by reference.

Here, characteristics of the embodiments of the female terminal fitting are collectively and briefly listed in [1] to [3] as follows.

[1] A female terminal fitting (1) including:
a female terminal main body (10) having a terminal fitting unit (11) with a quadrangular tube shape, into which a contact flat plate section (210) of a male terminal fitting is inserted as a connection counterpart; and
a terminal contact spring member (20) which is mounted on the terminal fitting unit (11) in a state of being in contact with an inner surface of the female terminal main body (10),
wherein the terminal contact spring member (20) includes:
   a first frame (21) having substantially a quadrangular shape which is inscribed in a front end portion (11a) of the terminal fitting unit (11) as an insertion side of the contact flat plate section (210),
   a second frame (22) having substantially a quadrangular shape which is inscribed in a rear end portion (11b) of the terminal fitting unit (11),
   a first flat spring (23) which straddles over first facing walls (21a and 22a) of the first frame (21) and the second frame (22), which face one surface (211) of the contact flat plate section (210) which is inserted into the terminal fitting unit (11), and comes into elastic contact with the one surface (211) of the contact flat plate section (210), and
   a second flat spring (24) which straddles over second facing walls (21b and 22b) of the first frame (21) and the second frame (22), which face the other surface (212) of the contact flat plate section (210) which is inserted into the terminal fitting unit (11), and comes into elastic contact with the other surface (212) of the contact flat plate section (210),
wherein a height dimension (H3) of side wall sections (21c and 22c) he first frame (21) and the second frame (22) in a sheet thickness direction of the contact flat plate section (210) before being mounted is greater than an inner height dimension (H4) of the terminal fitting unit (11) corresponding thereto, and
curved shape portions (R), which enable the height dimension (H3) of the side wall sections (21c and 22c) to extend and contract in the height direction, are provided on the side wall sections (21c and 22c).

[2] In the female terminal fitting (1) according to [1], the terminal contact spring member (20) is formed by bending a conductive metal sheet into a quadrangular tube shape,
a mating portion (30) between the edges of the metal sheet is set on one side surface side when the bending is performed so as to form the quadrangular tube shape, and the side wall sections (21c and 22c) having the curved shape portion (R) are provided on the other side surface side.

[3] In the female terminal fitting (1) according to [2], side edges (S2 and S4) of side wall pieces (21f and 22f) extending from the first facing walls (21a and 22a) of the first frame (21) and the second frame (22) and side edges (S1 and S3) of side wall pieces (21g and 22g) extending from the second facing walls (21b and 22b) of the first frame (21) and the second frame (22) come into contact at the mating portion (30) of the terminal contact spring member (20), respectively, the contact between the side edges of the side wall pieces causes relative movement of the side wall pieces from each other to be regulated in a direction parallel to the insertion direction of the contact flat plate section (210).

### INDUSTRIAL APPLICABILITY

According to the female terminal fitting of the present invention, an electrical connection state becomes stable between a female terminal main body and a terminal contact spring member which comes into contact with a contact flat plate section of a terminal fitting, and thus stable electrical properties can be secured.

### REFERENCE SIGNS LIST

1 female terminal fitting

10 female terminal main body

11 terminal fitting unit

11a front end portion

11b rear end portion

12 electric wire connecting section

20 terminal contact spring member

21 first frame

21a first facing wall

21b second facing wall

21c, 21d side wall section

21e, 21f, 21g side wall piece

22 second frame

22a first facing wall

22b second facing wall

22c, 22d side wall section

22e, 22f, 22g side wall piece

23 first flat spring

24 second flat spring

30 mating portion

210 contact flat plate section

211 one surface

212 the other surface

R curved shape portion

S1, S2, S3, S4 side edge

1. A female terminal fitting comprising:
a female terminal main body having a terminal fitting unit with a quadrangular tube shape, into which a contact flat plate section of a male terminal fitting is inserted as a connection counterpart; and
a terminal contact spring member which is mounted on the terminal fitting unit in a state of being in contact with an inner surface of the female terminal main body,
wherein the terminal contact spring member includes:
a first frame having substantially a quadrangular shape which is inscribed in a front end portion of the terminal fitting unit as an insertion side of the contact flat plate section,
a second frame having substantially a quadrangular shape which is inscribed in a rear end portion of the terminal fitting unit,
a first flat spring which straddles over first facing walls of the first frame and the second frame which face one surface of the contact flat plate section which is inserted into the terminal fitting unit, and comes into elastic contact with the one surface of the contact flat plate section, and
a second flat spring which straddles over second facing walls of the first frame and the second frame which face the other surface of the contact flat plate section which is inserted into the terminal fitting unit, and comes into elastic contact with the other surface of the contact flat plate section, and
wherein a height dimension of side wall sections of the first frame and the second frame in a sheet thickness direction of the contact flat plate section before being mounted is greater than an inner height dimension of the terminal fitting unit corresponding thereto, and
a curved shape portion, which enables the height dimension of the side wall sections to extend and contract in the height direction, is provided on the side wall section.

2. The female terminal fitting according to claim 1, wherein
the terminal contact spring member is formed by bending a conductive metal sheet into a quadrangular tube shape, and
a mating portion between edges of the metal sheet is set on one side surface side when the bending is performed so as to form the quadrangular tube shape, and the side wall sections having the curved shape portion are provided on the other side surface side.

3. The female terminal fitting according to claim 2, wherein
side edges of side wall pieces extending from the first facing walls of the first frame and the second frame and side edges of side wall pieces extending from the second facing walls of the first frame and the second frame come into contact at the mating portion of the terminal contact spring member, respectively, and
the contact between the side edges of the side wall pieces causes relative movement of the side wall pieces from each other to be regulated in a direction parallel to the insertion direction of the contact flat plate section.
